(19) United States
(12) Patent Application Publication
(10) Pub. No.: US 2015/0007776 A1
(43) Pub. Date: Jan. 8, 2015

(54) Washable, Collapsible Pet Bed

(71) Applicants: Justin Dees, West Hollywood, CA (US); Jesika Dees, Beaumont, TX (US)

(72) Inventors: Justin Dees, West Hollywood, CA (US); Jesika Dees, Beaumont, TX (US)

(21) Appl. No.: 14/263,614

(22) Filed: Apr. 28, 2014

Related U.S. Application Data
(60) Provisional application No. 61/817,191, filed on Apr. 29, 2013.

(51) Int. Cl. A01K 1/035

(52) U.S. Cl. CPC A01K 1/0353
USPC 119/28.5

(57) ABSTRACT

A washable, collapsible pet bed comprising a cylindrical main body, front collar, and back end piece. The front collar is embedded with a flexible ring, which provides support to the collar and overall shape to the pet bed, while being flexible to allow the pet bed to placed in a household washing machine. The pet bed is also collapsible to allow for easy transport and storage.

### CROSS-REFERENCE TO RELATED APPLICATION

This application claims priority to U.S. Provisional Application No. 61/817,191, filed Apr. 29, 2013, entitled, “Washable, Collapsible Pet Bed,” which is hereby incorporated by reference in its entirety.

### BACKGROUND OF THE INVENTION

1. Field of the Invention

The present invention relates to pet beds, in particular, to a machine-washable, collapsible pet bed, suitable for use by various breeds of dogs, cats, and other domestic animals.

2. Description of the Related Art

Traditional pet beds are simply cushions for a pet to sit or lie on top of. Cats and dogs, however, are understood to be den animals by nature, and therefore, may prefer a bed that mimics a den in which it can burrow.

Another common problem with pet beds is that they become quite dirty from pet hair, dirt, pests, and the like that come with having a pet. As such, these pet beds often require regular cleaning. However, most pet beds are not designed to be washed and, therefore, owners resort to less satisfactory methods such as “spot-cleaning” and vacuuming. Indeed, many traditional beds are neither machine-washable nor able to withstand regular washing. Some traditional pet beds have an outside shell that can be washed, but all parts are not machine-washable. Lack of adequate cleaning contributes to the spread of germs.

Another problem is that pet beds tend to be bulky and are space-consuming and thus not well-suited for traveling, general transport and/or storage.

### SUMMARY OF THE INVENTION

The pet bed of the present invention addresses many of deficiencies of the aforementioned traditional pet beds. The pet bed of the present invention is cylindrical, or tubular, to mimic a “cave-like” environment for the pet, providing comfort to the animal. A lining provided along the inside of the pet bed can give additional comfort to the animal. To facilitate easy access in and out of the pet bed by the pet, the pet bed includes an opening through a front collar provided as part of the pet bed.

The pet bed of the present invention, unlike traditional pet beds, is entirely machine-washable and designed to withstand regular washing. One feature of the present invention is an inner lining of the bed that can be pulled out from the pet bed through the front collar to allow for thorough washing, but the inner lining remains attached to the pet bed so that it does not become separated from the rest of the pet bed.

As mentioned above, traditional pet beds are mere cushions and simply do not travel well. When not in use, the pet bed of the present invention can collapse onto itself (as an accordion would), making it easy and convenient to store and carry. While in an expanded position, the pet bed of the present invention can generally hold its shape (described in further detail below) to comfortably fit the pet within its enclosure.

The pet bed in accordance with one aspect of the present invention comprises a cylindrical main body; a front collar attached at one end of said cylindrical main body, the front collar having an inner circumference and an outer circumference, the inner circumference defining an opening for a pet to enter and exit; and a circular back end piece having a circumference, the circular back end piece attached to the other end of said cylindrical body.

Other aspects of the present invention include that the pet bed can be machine-washable. The cylindrical main body can be collapsible on itself, and in a collapsed state, the cylindrical main body is sandwiched between said front collar and circular back end piece. The pet bed can be capable of being placed in a household washing machine. The pet bed can further comprise an inner lining. The inner lining can be pulled out of the cylindrical main body but remains attached to the pet bed to allow for thorough washing. The outer circumference of the front collar can be approximately the same as the circumference of the circular back end piece. A flexible ring can be embedded in the outer circumference of the front collar. The front collar can be supported by the flexible ring. The flexible ring can have a main tubular body. The main tubular body of the flexible ring can have two end pieces connected by an adapter.

In another aspect of the present invention, the collapsible, machine-washable pet bed comprises a main body; a front collar attached to said main body; and a back end piece attached to said main body; wherein said main body is collapsible on itself; wherein a flexible ring is embedded in said front collar; and wherein the pet bed is capable of being washed in a household washing machine.

### BRIEF DESCRIPTION OF THE DRAWINGS

FIG. 1 shows the pet bed of the present invention in use by a pet;

FIG. 2 shows the pet bed of the present invention in its collapsed state; and

FIG. 3 shows the flexible ring and adaptor/double edge connector of the present invention.

### DETAILED DESCRIPTION OF THE INVENTION

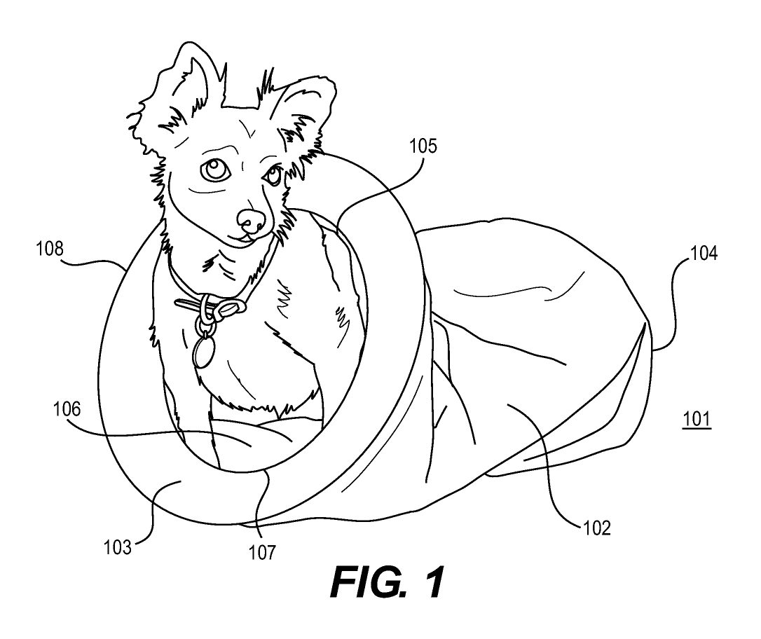

FIG. 1 shows pet bed 101 of the present invention in use by a pet. Pet bed 101 has a cylindrical main body 102, a front collar 103, and back end piece 104.

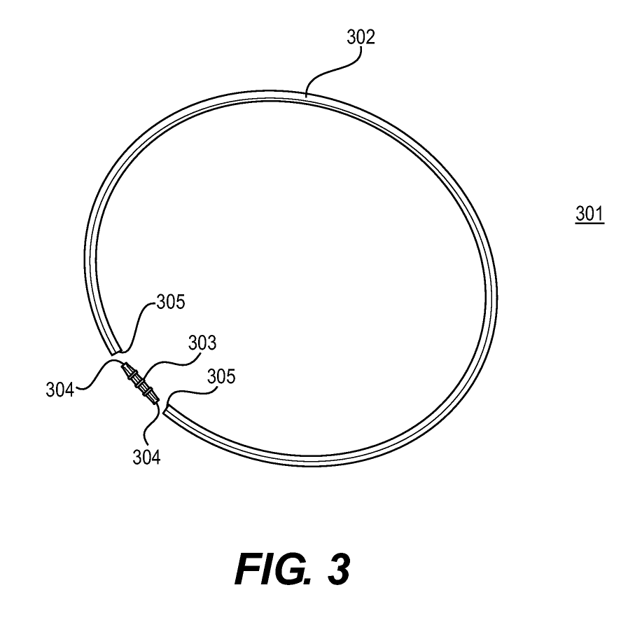

Front collar 103 is generally circular and has an inner circumference 107 and outer circumference 108, wherein the inner circumference 107 is less than the outer circumference 108. Inner circumference 107 is generally sized to allow a pet to enter therethrough. Front collar 103 is supported by a flexible ring (shown in FIG. 3), which is embedded in the outer circumference 108 of the front collar 103.

Back end piece 104 is also circular. Cylindrical main body 102 connects front collar 103 and back end piece 104, creating a tube-like structure for a pet to fit in. The outer circumference 108 of the front collar 103 and the circumference of back end piece 104 are approximately the same.

The front collar 103 defines an opening 105 for pet to enter and exit through. The opening 105 also allows the pet to keep its head out of the pet bed 101 as shown in the figure. The pet bed 101 also has an inner lining 106, preferably made of a soft material, which can provide additional comfort to the pet.

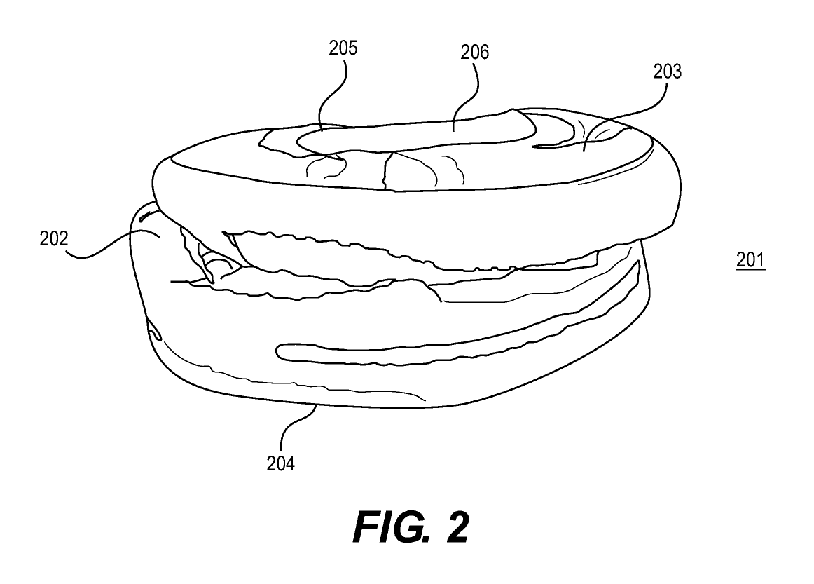

FIG. 2 shows pet bed 201 of the present invention in a generally collapsed state. Pet bed 201 also has a cylindrical main body 202, front collar 203, and back end piece 204. The front collar 203 defines an opening 205. Pet bed 201 is also lined with inner lining 206. The cylindrical main body 202 is made of a material, such as fabric, that is collapsible on itself, as shown in the FIG. 2. The collapsing feature is much like how an accordion folds onto itself. This allows for easy transport and storage of pet bed 201.

FIG. 3 shows flexible ring 301 of the present invention. Flexible ring 301 has a main tubular body 302, with two ends 305. Adaptor or double edge connector 303 has two tapered ends 304 which can fit inside ends 305 of the tubular main body 302 to create a ring. The flexible ring 301 is embedded or placed in the outer circumference portion of the front collar, providing structure to the front collar and general shape/support to the pet bed. The flexible ring 301 is generally assembled after insertion into the outer circumference portion of the front collar using adapter or double edge connector 303, which joins the two ends 305 of the main tubular body 302 as shown in FIG. 3.

An encasing fabric can also be used to hold the flexible ring 301 inside the front collar of the pet bed stable. The flexible ring 301 is able to be bend to fit in various shapes and sizes of washing machines, and is able to withstand machine washings.

Various materials can be used for the present invention. For example, the inner liner can be any suitable material, for example, but not limited to, Sherpa, cotton, polyester, etc. Similarly, the cylindrical body, front collar, and back end piece can be made of any suitable material, but preferably one that is both durable and machine washable, such as denim, canvas, or the like. In one embodiment of the present invention, the materials used are both non-rigid and collapsible.

The flexible ring of the present invention can be made from a plastic or other suitable material, flexible, semi-flexible, semi-rigid, or the like. The flexible ring can be made of a material that enables the ring to be bent to fit through an opening of a household washing machine. In one embodiment, the size of the ring does not exceed the size of the circumference of an inner cylinder of a washing machine.

The pet bed of the present invention can be sized to fit any pet. In one embodiment of the present invention, the pet bed is sized to be only slightly larger than the pet, to minimize the overall size of the bed. In another embodiment of the present invention, the opening is sized to be larger than the girth of the pet, so that it can fit easily through the opening.

The following is one general method in which the pet bed in accordance with the present invention can be made, but manufacturing is not limited to this method and not necessarily limited to the steps in which they are described or in the particular order described:
(1) Prepare templates for the front collar (two half circles) and back end piece (full circle) of the pet bed and cut fabric for outside portions and inner lining;
(2) Cut fabric for main body and inner lining therefor; sew together fabric leaving a gap so pet bed can be turned right side out;
(3) Cut “encasing fabric” for the flexible tube;
(4) Put together the front collar by sewing half circles together;
(5) Put together inner lining pieces;
(6) Attach the main body, front collar and tube encasing fabric;
(7) Attach the inner lining to the front collar;
(8) Insert rubber tubing through the encasing fabric; and
(9) Sew together all parts except gap, turn bed inside out, and sew the gap.

Although the invention has been described in detail with reference to a particular embodiments, persons possessing ordinary skill in the art to which this invention pertains will appreciate that various modifications and enhancements may be made without departing from the spirit and scope of the claims that follow.

We claim:

1. A pet bed comprising:
a cylindrical main body;
a front collar attached at one end of said cylindrical main body, the front collar having an inner circumference and an outer circumference, the inner circumference defining an opening for a pet to enter and exit; and
a circular back end piece having a circumference, the circular back end piece attached to the other end of said cylindrical body.

2. The pet bed of claim 1, wherein the pet bed is machine-washable.

3. The pet bed of claim 1, wherein the cylindrical main body is collapsible on itself, and in a collapsed state, the cylindrical main body is sandwiched between said front collar and circular back end piece.

4. The pet bed of claim 1, wherein the pet bed is capable of being placed in a household washing machine.

5. The pet bed of claim 1, wherein the pet bed further comprises an inner lining.

6. The pet bed of claim 1, wherein the outer circumference of the front collar is approximately the same as the circumference of the circular back end piece.

7. The pet bed of claim 1, wherein a flexible ring is embedded in the outer circumference of the front collar.

8. The pet bed of claim 7, wherein the front collar is supported by the flexible ring.

9. The pet bed of claim 7, wherein the flexible ring is has a main tubular body.

10. The pet bed of claim 9, wherein the main tubular body of the flexible ring has two end pieces connected by an adapter.

11. The pet bed of claim 5, wherein the inner lining can be pulled out of the cylindrical main body but remains attached to the pet bed to allow for thorough washing.

12. A collapsible, machine-washable pet bed comprising:
a main body;
a front collar attached to said main body; and
a back end piece attached to said main body;
wherein said main body is collapsible on itself;
wherein a flexible ring is embedded in said front collar; and
wherein the pet bed is capable of being washed in a household washing machine.
